(19) United States
(12) Patent Application Publication
(10) Pub. No.: US 2007/0204027 A1
(43) Pub. Date: Aug. 30, 2007

(54) Method for displaying a real-time message on a mobile communication device

(76) Inventors: Ming-Shan Shih, Taoyuan Hsien (TW); Kao-Szu Lee, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/645,558

(22) Filed: Dec. 27, 2006

(30) Foreign Application Priority Data
Feb. 24, 2006 (TW) 95106434

(51) Int. Cl. G06F 15/173

(52) U.S. Cl. 709/223; 709/203

(57) ABSTRACT

A method for displaying a real-time message on a mobile communication device is applied to a mobile communication device linked to the Internet. When the mobile communication device is linked to an access point or is turned on, a webpage or data navigating program is executed, and the contents provided by the Internet service supplier are displayed. Thereby, a real-time message is displayed, or a commercial promotion message is displayed to advertise a commercial activity. The method includes searching an Internet accessing device to link to the Internet, automatically executing a navigating program, linking to an Internet server predetermined by the Internet, and displaying a page provided by the Internet server. The page can include log in information, product marketing contents, or real-time information, personalized information, on-line shopping information or a personalized webpage of an online store.

### BACKGROUND OF THE INVENTION

1. Field of the Invention

The present invention relates to a method for displaying a real-time message on a mobile communication device. In particular, this invention relates to a method that displays a specific page by instantly executing a browser to generate an advertisement displaying function or a real-time message displaying function.

2. Description of the Related Art

Due to mobile communication becoming popular, mobile communication devices need to be able to link to a network. For example, the user uses a PDA or a cell phone to link to the Internet for navigating or exchanging data.

U.S. Pat. No. 6,473,609 (application date: 14, Sep. 1998) discloses a method and architecture for interactive two-way communication devices to interact with a network, as shown in FIG. 1. In an environment for mobile communication, a plurality of mobile devices 11, 12, 13 are linked to network (including the Internet, a private network, a corporation network, etc.) via a remote station 108, a bridging device (server) 114, and by linking to a remote personal computer 110 and the Internet server 104. Thereby, the user can navigate content provided by the personal computer 110 or the Internet server 104 via the mobile devices 11, 12, 13.

U.S. Pat. No. 6,941,273 discloses a telephony-data application interface apparatus and method for multiple modal access to data applications. It utilizes a telephone or an Internet browser to link to the Internet via a PSTN and a telephony-network interface. Thereby, the user can make purchases by a voice or the browser.

However, the described methods are only applied to a cell phone. It utilizes 3G or GPRS to link to the Internet. For example, the user utilizes a browser to link to an Internet server for shopping, downloading data, etc. The mobile device, as disclosed in U.S. Pat. No. 6,952,414, Portable Internet browser Device with Cordless Phone Module and Method for Operation, is a wireless telephone module. It can link to the telephone network and the data network, and navigate a webpage.

### SUMMARY OF THE INVENTION

A method for displaying a real-time message on a mobile communication device is applied to mobile communication devices capable of linking to the Internet, such as cell phones, PDAs, or other such mobile devices. When the mobile device utilizes wireless communication to link to the Internet, it searches the accessing point (AP), the station, or hotspot to link to the Internet. When the user uses the mobile deice to link to the wireless hotspot by an automatic method or a manual method, the present invention executes a webpage or data navigating program to display the contents provided by the Internet service supplier. Thereby, a commercial action is begun.

In an embodiment, the steps of the method for displaying a real-time message on a mobile communication device include searching an Internet accessing device to link to the Internet after the mobile communication device is turned on, automatically executing a navigating program, linking to an Internet server predetermined by the Internet, and displaying a specific page provided by the Internet server. The page can provide login information, a product marketing contents, or real-time information—such as weather, news, traffic information, personalized information, on-line shopping information or a personalized webpage of a website.

In another embodiment, the steps of the method for displaying a real-time message on a mobile communication device include searching an Internet accessing device to link to the Internet after the mobile communication device is turned on and the Internet is set, automatically executing a navigating program for the mobile communication device to obtain personalized information, linking and sending the personal information to an Internet server predetermined by the Internet for generating personalized content, and displaying a page via a browser according to the personalized content.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the Internet of the prior art;

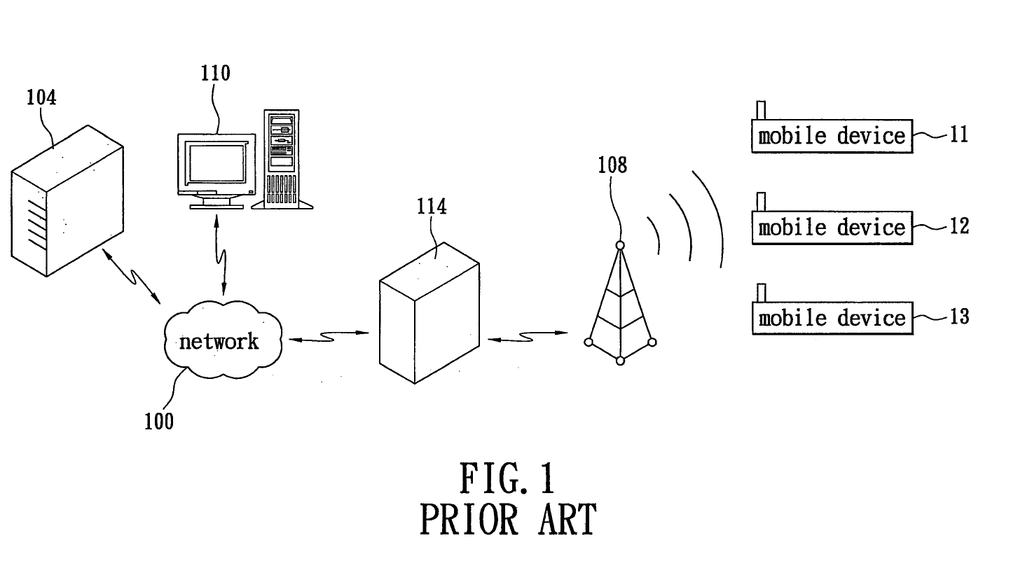

FIG. 2 is a schematic diagram of the mobile communication network of the present invention;

FIG. 3A is a first perspective view of displaying the information of the present invention;

FIG. 3B is a second perspective view of displaying the information of the present invention;

FIG. 3C is a third perspective view of displaying the information of the present invention;

FIG. 3D is a fourth perspective view of displaying the information of the present invention;

FIG. 4 is a flow chart of the method for displaying a real-time message on a mobile communication device of the first embodiment of the present invention;

FIG. 5 is a flow chart of the method for displaying a real-time message on a mobile communication device of the second embodiment of the present invention; and

FIG. 6 is a flow chart of the method for displaying a real-time message on a mobile communication device of the third embodiment of the present invention.

### DETAILED DESCRIPTION OF THE PREFERRED EMBODIMENTS

The present invention utilizes mobile Internet technology to provide a method for displaying a real-time message on a mobile communication device. Thereby, real-time commercial or non-commercial messages are displayed on the mobile communication device linked to the Internet.

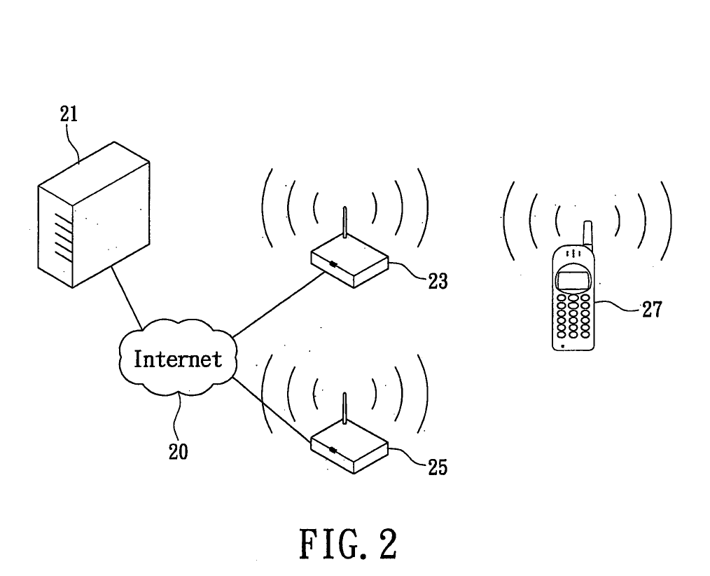

Reference is made to FIG. 2, which shows a schematic diagram of the mobile communication network. The user uses a mobile communication device 27 to link to the Internet for navigating a webpage or data, such as a cell phone, a PDA, or other mobile devices linked to the Internet. The mobile communication device 27 has an operating system, a tool program for linking to the Internet, and a webpage or data navigating program, such as Internet Explorer (IE) in the Windows CE. The navigating program also can be installed in PalmOS, SymbianOS, VxWorksOS, or LinuxOS) that are suitable for mobile devices. The mobile communication device 27 is linked to an access point or a wireless station by a wireless method, such as a hotspot built in a specified location—the first accessing device 23 and the second accessing device 25 in FIG. 2. The mobile communication device 27 is located within the range of the electromagnetic wave emitting from the first accessing device 23. An initializing process, including hotspot login verification, manually or automatically downloading the network setting values of the accessing device (including at least an Internet address, an Internet mask value, a channel host address, a named server address, etc.), or displaying the information provided by the accessing device provider, is executed. After the use passes the initializing process, the user can utilize the mobile communication device 27 to link to the Internet, and obtains messages from a specified server 21 and navigates the displayed message by the navigating program in the mobile communication device 27.

The mobile communication device 27 is located within the Internet range of the first accessing device 23, and displays or receives the message obtained from the first accessing device 23. When the mobile communication device 27 moves to within the range of the electromagnetic wave emitting from the second accessing device 25, the mobile communication device 27 updates the message, and displays and downloads the contents of the second accessing device 25.

The present invention further provides a method for displaying a real-time message to the provider of the accessing devices 23, 25. It automatically displays the message on the navigating program in the mobile communication device. The goals of displaying the real-time message and displaying a commercial advertisement are achieved. After the mobile communication device is successfully linked to the Internet or turned on, the present invention automatically executes the data or webpage navigating program to download the data via the linked accessing device, and automatically displays the data on the mobile communication device of the user.

The accessing device is a wireless access point, wireless station, or other such devices for linking to the Internet. The wireless communication protocol can be 3G, GPRS, WiFi (802.11), etc. The displayed content or the default webpage provided by the hotspot or the accessing device is a product marketing advertisement of the hotspot supplier, marketing content from third parties, real-time marketing, information, news, weather, or other personalized services, etc.

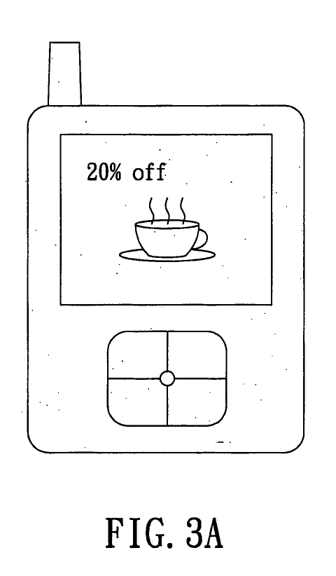

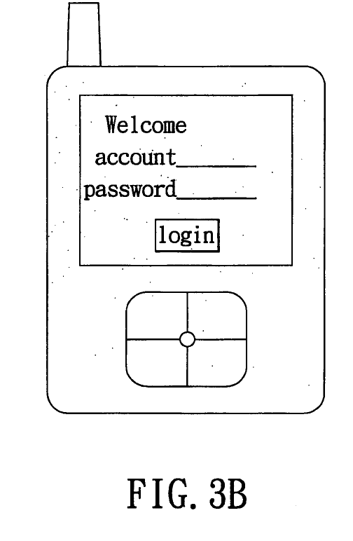

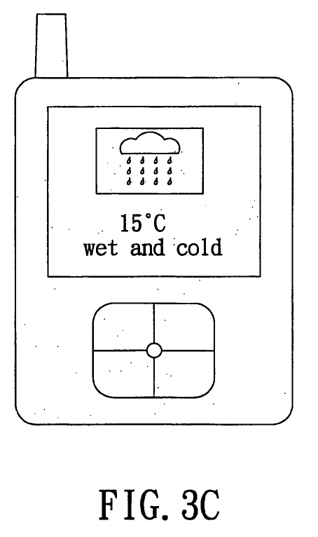

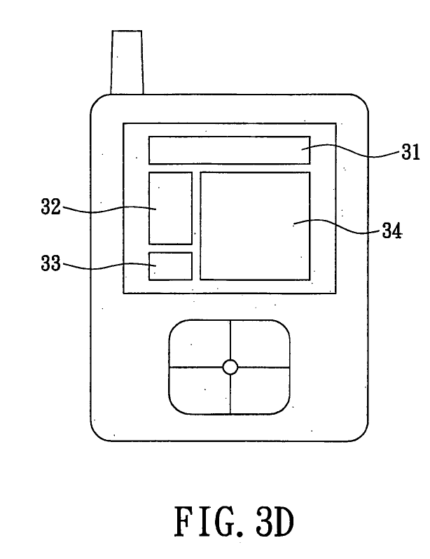

The method for displaying a real-time message on a mobile communication device includes displaying a page provided by the hotspot provider when the mobile communication device is linked to the hotspot, and displaying a specified advertisement or personalized message when the mobile communication device is linked to the Internet. FIGS. 3A˜3D show the pages displayed by the navigating program in the mobile communication device. The displayed page can be a hotspot login message, a product marketing content, an Internet provider's advertisement, a real-time message˜including weather, news, traffic information, etc, a personalized message—including destiny, trend, hobby, shopping information of a product located in the hotspot, or a personalized website for shopping, etc.

For example, FIG. 3A shows the product marketing content that is automatically provided from the linked hotspot when the mobile communication device is linked to the Internet and executes a data navigating program. FIG. 3A shows a 20% discount coupon as an example; a user can use the coupon when shopping on the Internet via the linked hotspot.

FIG. 3B shows the login message required for the user to access the Internet via the hotspot when the mobile communication device is linked to a specified accessing device and automatically executes data or a webpage navigating program. The user utilizes this page to log in to the hotspot for linking to Internet.

FIG. 3C shows a message sent when the user uses the mobile communication device to link to the Internet and no real-time messages are provided by the hotspot. The message can be weather, news, traffic information, etc. In this embodiment, the displayed message is weather. The displayed message is determined by the user's location.

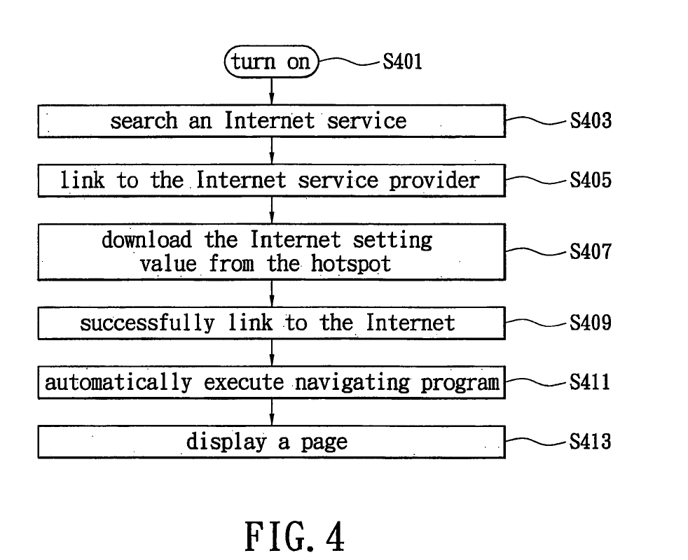

FIG. 4 shows the navigated page having a plurality of areas, including the first area 31, the second area 32, the third area 33, and the fourth area 34. The hotspot or Internet provider can sell real-time message pages sent to the mobile communication device. For example, when the mobile communication device provided from an advertising agency is linked to the Internet service provided by or invested in by the advertising agency, the method for displaying a real-time message on the mobile communication device displays the location and page bought by the advertiser by automatically executing the navigating program. The advertising agency divides the webpage into a plurality of areas, as shown in FIG. 3D. The first area 31 can be sold or rented out to the first advertiser to display a specified content. The second area 32 can be sold or rented out to the second advertiser to display a marketing content. The third area 33 can be sold or rented out to the third advertiser to display job recruitment content. The fourth area 34 can be sold or rented out to the fourth advertiser to display a specified advertisement.

The mobile communication device displaying the real-time message page in the data or webpage navigating program can advertise or promote for the specified advertiser. The page can be displayed by the following methods.

1. After the mobile communication device is turned on, the page is displayed instantly. For example, when a user turns on the cell phone, a PDA, or other device linking to the Internet, and establishes the settings for linking to the Internet by an automatic or manual method, the webpage or data navigating program is instantly started and is linked to a predetermined Internet server to display the specified content.

2. When the user operates the mobile communication device for a general purpose and does not link to the Internet, the webpage or data navigating program is not started. When the mobile communication device is linked to the Internet, the webpage or data navigating program is instantly executed and is linked to a predetermined Internet server to display the specific page.

3. After the user uses the mobile communication device to link to the Internet, the mobile communication device does not instantly execute the webpage or data navigating program. After the user executes the webpage or data navigating program, the mobile communication device is linked to a predetermined Internet server to display the specific page.

4. After the mobile communication device is linked to the Internet and the user executes the webpage or data navigating program, it does not instantly link to a predetermined Internet server to display the specific page. When the user visits the desired webpage, the specified content is automatically displayed.

The real-time message can be displayed on the mobile communication device by the following methods: displaying the real-time message after the mobile communication device is turned on, displaying the real-time message after the Internet linking process of the mobile communication device is executed, displaying the real-time message after the webpage or data navigating program is started, and displaying the real-time message when the user navigates a webpage.

The steps of the method for displaying a real-time message on a mobile communication device are shown in FIG. 4. After the mobile communication device is turned on (S401), the mobile communication device searches Internet services near the mobile communication device (S403). For example, the mobile communication device searches the access point or the hotspot. Next, the mobile communication device is linked to the access point provided from the Internet service provider by the user or system (S405). The Internet setting process is executed to download the Internet setting values from the access point (S407), including at least an Internet address, an Internet mask value, a gate host address, and a named server address. After the mobile communication device is successfully linked to the Internet service (S409), the method for displaying a real-time message on a mobile communication device automatically executes the data or webpage navigating program (a webpage browser that meets the HTTP—Hypertext Markup Language Homepage Protocol) to link to a default Internet server (S411) for displaying a specific page provided from the Internet server (S413). The specific page includes one or a plurality of real-time messages. In a preferred embodiment, a hypertext document is displayed. In order to achieve the goal of the present invention, the page cannot be escaped or omitted. The content of the page is the same as FIGS. 3A˜3D.

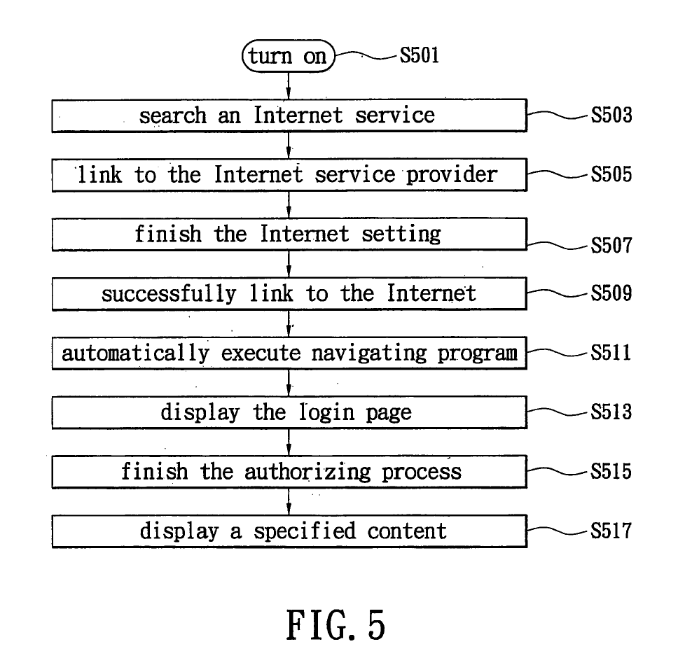

FIG. 5 shows the second embodiment of the method for displaying a real-time message on a mobile communication device of the present invention. After the mobile communication device is turned on (S501), the mobile communication device searches the Internet service near to the mobile communication device (S503). For example, the mobile communication device searches the access point. Next, the mobile communication device is linked to the access point provided from the Internet service provider by the user or system (S505). The Internet setting process is executed (S507). After the mobile communication device is successfully linked to the Internet service (S509), the navigating program is instantly and automatically executed (S511). In this embodiment, the mobile communication device is linked to an access point provided by a specific Internet service provider. If the user needs to be authorized via an authorizing process to link to the access point, a login page is displayed. The authorizing process includes sending the user account, password, a recognition identification (such as fingerprint, voiceprint etc.), or other verification methods (S513). After the user is authorized (S515), the mobile communication device uses the webpage or data navigating program to display content provided by the advertiser (S517).

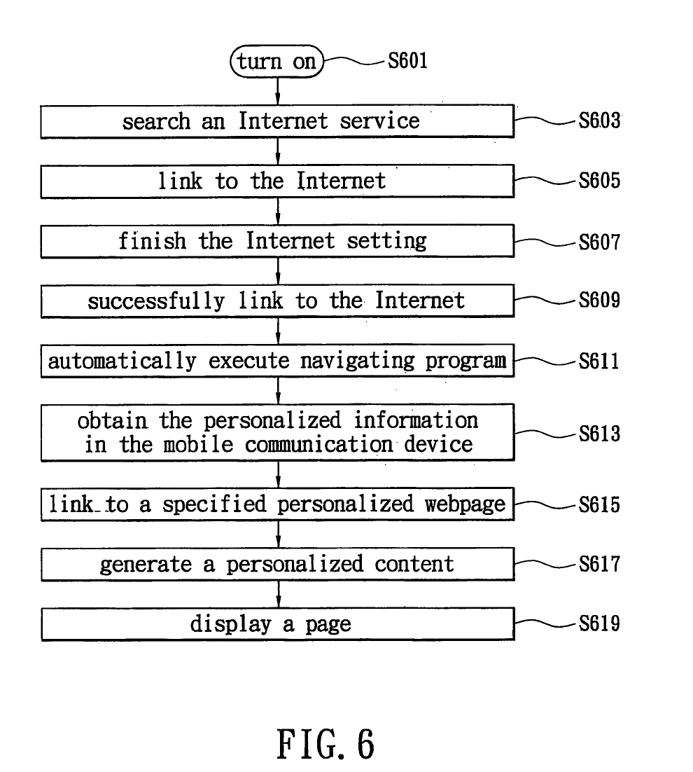

FIG. 6 shows the third embodiment of the method for displaying a real-time message on a mobile communication device of the present invention. The initial Internet setting is the same as the described embodiment. The method also utilizes the user's personal information set up in the mobile communication device to display personalized content. The personalized information includes, but is not limited to name, age, birthday, hobby, e-mail address, and address etc.

After the mobile communication device is turned on (S601), the mobile communication device searches the Internet service near to the mobile communication device (S603). For example, the mobile communication device searches the access point. Next, the mobile communication device is linked to the access point provided by the Internet service provider by the user or system (S605), and finishes the Internet setting process (S607). After the mobile communication device is successfully linked to the Internet service (S609), the navigating program is instantly and automatically executed (S611).

After the mobile communication device is successfully linked to the Internet service, and the navigating program is instantly and automatically executed, the mobile communication device obtains the personalized information (S613). Next, the mobile communication device is linked to a specified Internet server, and displays the personalized webpage or specified content (S615). The method also sends the personalized information to the Internet server and generates personalized content according to the personal information (S617). Finally, the mobile communication device displays the generated page according to the personalized content in the webpage or data navigating program (S619). In this embodiment, the personalized content can be related to star signs, trends, or hobbies. For example, a personalized star sign reading is obtained according to the user's birth date. By linking to the Internet and using the constellations and the current time, the day's and/or the week's horoscope can be obtained. Alternatively, encouraging ideas and sayings, or suggested items are displayed according to the user.

The method for displaying a real-time message on a mobile communication device is applied to mobile communication devices. The mobile communication device links to the Internet. When the mobile communication device is linked to the Internet or turned on, the webpage navigating program is instantly executed to display contents provided by the Internet service supplier. Thereby, a commercial action is begun.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A method for displaying a real-time message on a mobile communication device, the mobile communication device linking to the Internet, the steps comprising:
searching an Internet accessing device;
linking to the Internet, wherein the mobile communication device is linked to the Internet via the Internet accessing device;
automatically executing a navigating program;
linking to an Internet server predetermined by the Internet; and
displaying a page provided by the Internet server.

2. The method for displaying a real-time message on a mobile communication device as claimed in claim 1, wherein the navigating program is a webpage browser using HTTP protocol.

3. The method for displaying a real-time message on a mobile communication device as claimed in claim 1, wherein the page is a hypertext document.

4. The method for displaying a real-time message on a mobile communication device as claimed in claim 1, wherein the step of searching an Internet accessing device is searching a hotspot near to the mobile communication device.

5. The method for displaying a real-time message on a mobile communication device as claimed in claim 1, wherein the mobile communication device automatically sets the Internet setting and links to the Internet.

6. The method for displaying a real-time message on a mobile communication device as claimed in claim 1, wherein the page displays log in information for the Internet accessing device.

7. The method for displaying a real-time message on a mobile communication device as claimed in claim 1, wherein the page displays a product marketing content.

8. The method for displaying a real-time message on a mobile communication device as claimed in claim 1, wherein the page displays a real-time message, including weather, news, or traffic information.

9. The method for displaying a real-time message on a mobile communication device as claimed in claim 1, wherein the page displays personalized information.

10. The method for displaying a real-time message on a mobile communication device as claimed in claim 1, wherein the page displays on-line shopping information for a seller located within the Internet accessing device.

11. The method for displaying a real-time message on a mobile communication device as claimed in claim 1, wherein the page displays a personalized webpage.

12. A method for displaying a real-time message on a mobile communication device, the mobile communication device linking to the Internet, the steps comprising:
searching an Internet accessing device;
linking to the Internet, wherein the mobile communication device is linked to the Internet via the Internet accessing device;
automatically executing a navigating program;
obtaining personalized information from the mobile communication device;
linking to an Internet server predetermined by the Internet;
generating a personalized content; and
displaying a page according to the personalized content.

13. The method for displaying a real-time message on a mobile communication device as claimed in claim 12, wherein the navigating program is a webpage browser that uses HTTP protocol.

14. The method for displaying a real-time message on a mobile communication device as claimed in claim 12, wherein the page is a hypertext document.

15. The method for displaying a real-time message on a mobile communication device as claimed in claim 12, wherein the step of searching an Internet accessing device is searching a hotspot near to the mobile communication device.

16. The method for displaying a real-time message on a mobile communication device as claimed in claim 12, wherein the mobile communication device automatically sets the Internet setting and links to the Internet.
